(19) United States
(12) Patent Application Publication
(10) Pub. No.: US 2026/0141749 A1
(43) Pub. Date: May 21, 2026

(54) OCCLUSION-AWARE REAL-TIME TINY FACIAL ALIGNMENT MODEL FOR MAKEUP VIRTUAL TRY-ON

(71) Applicant: L'Oreal, Paris (FR)

(72) Inventors: Kin Ching Lydia CHAU, Toronto (CA); Zhi YU, Mississauga (CA); Ruowei JIANG, Mississauga (CA)

(73) Assignee: L'Oreal, Paris (FR)

(21) Appl. No.: 18/951,416

(22) Filed: Nov. 18, 2024

(51) Int. Cl. G06V 40/16; A45D 44/00; G06V 10/25; G06V 10/26; G06V 10/764; G06V 10/82

(52) U.S. Cl. CPC G06V 40/171; A45D 44/005; G06V 10/25; G06V 10/26; G06V 10/764; G06V 10/82

(57) ABSTRACT

Real-time makeup virtual try-on (VTO) on resource-constrained platforms like mobile devices and web browsers demands a delicate balance: models must be accurate enough for realistic results yet lightweight and fast enough for smooth performance. Existing approaches often rely on separate models for facial landmark detection and occlusion-aware segmentation, increasing complexity and hindering real-time performance. There is proposed, in accordance with embodiments, a unified model that performs both tasks within a single, highly efficient architecture. Specifically designed for VTO, the model offers enhanced accuracy around critical areas like the eyes and lips. Operations can be further optimized for real-time performance by leveraging temporal information: predictions from previous video frames guide current predictions, increasing parallelism and reducing inference time. Trained with a simplified pipeline, the unified model achieves accuracy comparable to state-of-the-art lightweight alignment models while maintaining a small footprint.

### FIELD OF INVENTION

This application relates to computer image processing using a trained model and more particularly to processing images with an occlusion-aware real-time tiny facial alignment model such as for makeup virtual try-on (VTO).

### BACKGROUND

Facial alignment is a fundamental step in many makeup VTO applications. Such applications rely on face alignment models to locate regions for rendering various makeup effects. While traditional VTO applications focused on images, recent advancements have enabled real-time makeup rendering during video calls and live streams.

However, real-time makeup VTO presents unique challenges. Users are no longer stationary; their movements, combined with potential occlusions like hands or other objects, can hinder VTO performance. To address this, real-time VTO applications require robust solutions that can maintain accurate facial landmark prediction in real time while also effectively handling occlusions, ensuring virtual makeup is only applied to visible areas of the face. This can be achieved by integrating an external face-parsing model alongside the face alignment model to manage occlusion scenarios.

While real-time face alignment and face parsing models exist, integrating multiple models into applications often leads to increased system complexity, larger model sizes, and slower inference times. This raises a significant challenge, particularly for resource-constrained environments like web applications.

### SUMMARY

To overcome these limitations, in an embodiment there is proposed a novel, compact model that unifies face alignment and segmentation. An embodiment model provides two types of segmentation modules: a lip segmentation module (e.g. for lip makeup rendering) and a face segmentation module (e.g. for makeup effects that affect any part of the face). In an embodiment, both modules are lightweight, with the lip segmentation branch being slightly smaller than the face segmentation branch. In an embodiment, users are allowed to choose the appropriate module based on their needs. By unifying these tasks into a single, efficient model, a way is paved for more accessible, robust, and smooth real-time makeup virtual try-on experiences.

### BRIEF DESCRIPTION OF THE DRAWINGS

FIG. 1 shows annotated images that visualize 65 predicted landmarks, a lip segmentation mask, a full face bounding box, locations of the eye and lip region of interest (RoI) crops as well as Illustrations of the face segmentation result.

FIG. 2 shows an Illustration of the 65 landmarks in more detail and in accordance with an embodiment.

FIG. 3 is a block diagram showing an overview of a network structure in accordance with an embodiment.

FIGS. 4A and 4B are block diagrams showing further details of portions of FIG. 3 in accordance with embodiments.

FIG. 5 is a flowchart of operations for a caching of face points in accordance with an embodiment.

FIG. 6 is a graph providing a comparison of landmark NME based on 300-W full set, number of model parameters (M) and FLOPs (G) with other models.

FIG. 7 is an illustration of a computing environment, in accordance with an embodiment, such as for performing a virtual try on.

FIG. 8 is a block diagram showing an overview of a further network structure in accordance with an embodiment.

FIG. 9 is a block diagram of occlusion branch in accordance with an embodiment.

FIG. 10 is a set of images showing before and after lip points annotations in accordance with embodiments.

FIG. 11 is a flowchart of operations for training a network structure in accordance with an embodiment.

FIG. 12 is a flowchart of operations for simulating a makeup effect in accordance with an embodiment.

### DETAILED DESCRIPTION

In an embodiment a novel facial alignment network structure is tailored to virtual try-on tasks. With improved eye and lip region focus and segmentation support in one network, the network overcomes the challenges in occlusion rendering on state-of-the-art networks.

In an embodiment a lightweight unified face alignment and segmentation model is provided that can be executed in real-time on web applications. The proposed alignment modules demonstrate superior speed and posses a smaller model size while maintaining landmark accuracy comparable to state-of-the-art models. In an embodiment, lightweight segmentation modules accurately identify visible facial regions, enabling effective handling of occlusions for more realistic virtual makeup applications.

In an embodiment a real-time inference pipeline enhances parallelism among model branches by leveraging temporal information. The approach utilizes the lip and eye locations predicted in the previous frame to guide the prediction of eye and lip regions in the current frame.

Real-time makeup virtual try-on (VTO) web applications present a challenge for deep learning models: there is a desire that they are small and fast enough for smooth performance on devices with limited processing power, yet accurate enough to produce realistic makeup effects. This balance is often achieved through efficient model architectures and training techniques like knowledge distillation. Backbones like ShuffleNet (X. Zhang, X. Zhou, M. Lin, and J. Sun, ‘Shufflenet: An extremely efficient convolutional neural network for mobile devices’, in Proceedings of the IEEE conference on computer vision and pattern recognition, 2018, pp. 6848-6856, incorporated herein by reference), MobileNet (A. G. Howard, ‘MobileNets: Efficient convolutional neural networks for mobile vision applications’, arXiv preprint arXiv:1704. 04861, 2017, incorporated herein by reference), and E-ELAN (C.-Y. Wang, A. Bochkovskiy, and H.-Y. M. Liao, ‘YOLOv7: Trainable bag-of-freebies sets new state-of-the-art for real-time object detectors’, in Proceedings of the IEEE/CVF conference on computer vision and pattern recognition, 2023, pp. 7464-7475, incorporated herein by reference) have successfully reduced model size without significantly compromising performance across various computer vision tasks. Inspired by the recent success of MobileNet-based models such as Mobileone of Vasu et al., and Mobilevit of Mehta et al, and their use of inverted residual blocks, in accordance with embodiments, there is proposed a novel, highly efficient architecture specifically designed and optimized for the unique demands of facial alignment and segmentation in makeup VTO.

Occlusion, where objects block parts of the face, presents a significant challenge for accurate facial alignment in virtual try-on (VTO) applications. While existing techniques try to address this by masking facial regions during training to improve robustness, VTO benefits from more than just accurate facial landmarks. It is improved with precise knowledge of the visible areas of the face to apply makeup realistically.

In accordance with embodiments, incorporating occlusion-aware segmentation methods that use synthetically generated occlusions, introduced are novelly specialized segmentation branches to the model, trained on images augmented with synthetic occlusions. These branches effectively segment the visible portions of the lips and face, enabling accurate and robust VTO even when occlusions are present.

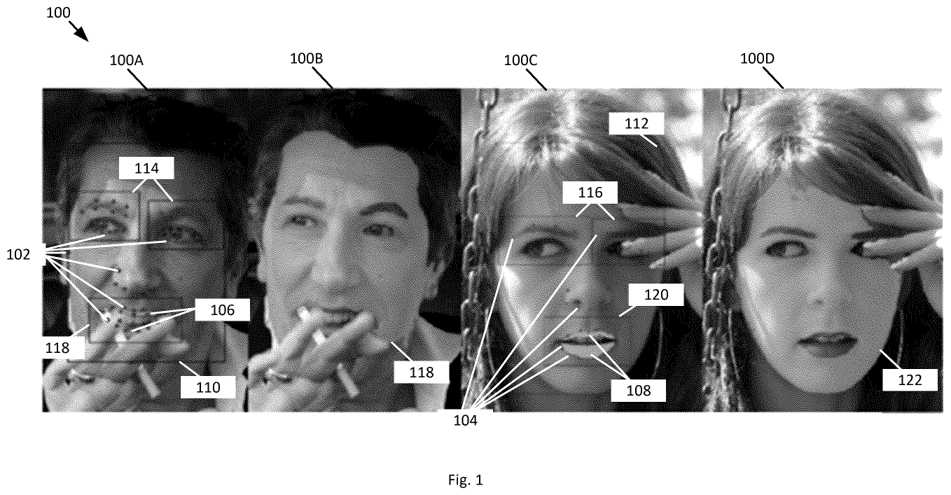

Landmark Data: Popular public face alignment datasets typically contain 68, 98, or 29 facial landmarks. However, for the target application of makeup VTO, a denser representation of landmarks around the eyebrows, eyes, lips, and nose wings is desirable, as these are the areas where makeup is typically applied. While 29 landmarks are too sparse for this purpose, the 68- and 98-landmark datasets lack sufficient detail to capture the upper and lower edges of the eyebrows. Therefore, in an embodiment there is defined a 65-landmark coordinate system, illustrated in FIG. 1, which prioritizes denser inner face points while utilizing fewer contour points.

FIG. 1 shows annotated images 100 including first pair 100A, 100B and second pair 100C and 100D. Images 100A and 100C show annotations that visualize the predicted 65 landmarks (e.g. 102, 104), lip segmentation mask (106, 108) (e.g. a binary mask denoting pixels that are lip pixels), full face bounding box (110, 112), the locations of the eye (e.g. 114, 116) and lip RoI crops (118, 120) on images. Images 100B and 100D show Illustrations of the face segmentation mask result 122, 124. In an embodiment, the face segmentation mask comprises a binary mask denoting pixels that are face skin pixels.

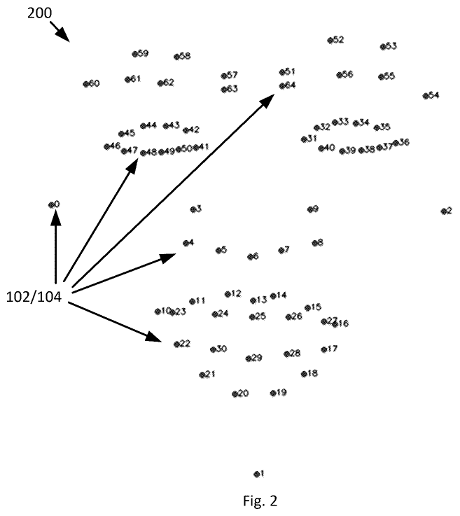

FIG. 2 shows an Illustration 200 of the 65 landmarks corresponding to landmarks 102/104 of FIG. 1, in accordance with an embodiment. The landmarks are numbered in accordance with an embodiment and groups thereof may define facial structures as face boundary (landmarks 0-2), lower nose (3-9), upper lip (10-16 and 23-27), lower lip (17-22 and 28-30), right eye (31-40), left eye (41-50), right brow (51-56 and 64), and left brow (57-63).

A dataset of 6,000 subjects spanning various ages, genders, and skin tones was collected. All images are free of occlusions and are manually annotated using the 65-landmark definition. Because the forehead is essential for makeup try-on, the images were cropped using bounding boxes encompassing the area between the upper hairline and chin. This contrasts with the bounding boxes used in popular public datasets, which are based on the minimum and maximum coordinates of all landmarks. When training the eye branch, eyebrow points are included as part of the eye points such that the eye points output includes points for the eye and the brow. The images are resized to 256×256 pixels and perform random color jittering, shifting, and scaling augmentation during training for all branches.

Occlusion Data: In an embodiment, to augment the dataset with realistic occlusions, there was simulated real-life scenarios using the same set of images. A library of commonly seen occlusion objects was complied, such as hands, mugs, glasses, masks, and phones. For glasses and masks, facial landmarks were leveraged to ensure accurate positioning on the images, while other objects are placed randomly near the subjects' faces. The ground truth landmarks remain unaffected by these occlusions. Segmentation masks were computed by calculating the intersection between the original mask and the newly visible area.

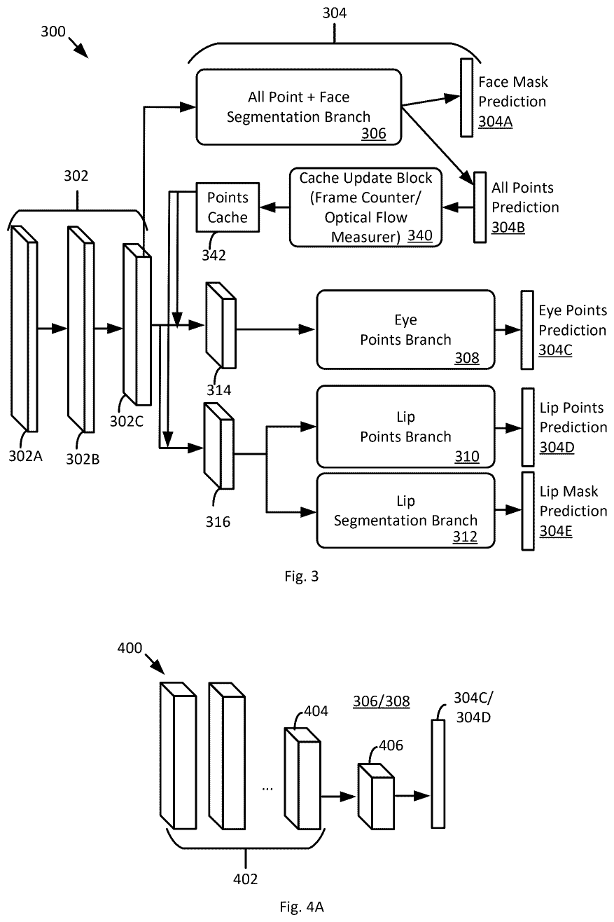

Model Architecture: FIG. 3 is a block diagram showing an overview of a network structure 300 (model architecture) for a face tracker in accordance with an embodiment. At inference time, the graphics rendering of make up effects is calculated based on the intersection of respective points predictions and mask segmentations (e.g. for eyes and lips). To achieve optimal makeup rendering effects, the network structure is tailored to focus on the lip and eye regions, separating the network into the five distinct components.

Network structure 300 comprises a shared backbone 302 and the network branch components (collectively 304) providing five outputs. Also shown is cache update block 340 and a points cache 342 for leveraging block parallelism.

Backbone 302 comprises an input face crop block 302A, a convolutional layer block 302B and an inverted residual block 302C. Block 302C provides encoded features for processing by branch components 304.

Branch components 304 include an all points+face segmentation branch 306, an eye points branch 308, a lip points branch 310 and a lip segmentation branch 312. Eye point branch 308 and lip point branch 310 are prefaced by eye crops block 314 and lip crop block 316, respectively. These blocks 314 and 316 each crop encoded features from block 302C in response to respective initial lip and eye points determined from predictions of block 306. The lip and eye points are cached (stored) to points cache 342 as directed by cache update block 340.

The outputs of blocks 306, 308, 310 and 312 comprise a face mask prediction 304A, an all points prediction 304B, an eye points prediction 304C, a lip points prediction 304D, and a lip mask prediction 304E. It is understood that the points type predictions comprise regressions and the mask type predictions comprise segmentations.

In an embodiment, following operations of the shared backbone 302, network structure 300 is configured to first perform operations of the all points branch 306 to calculate the RoI crop of the face (e.g. all points prediction 304B thar determines face points). Structure 300 is configured to then perform the remining operations of branch 306 for face segmentation as well as operations of branches 308-312 to calculate regional predictions (e.g. 304C to 304E).

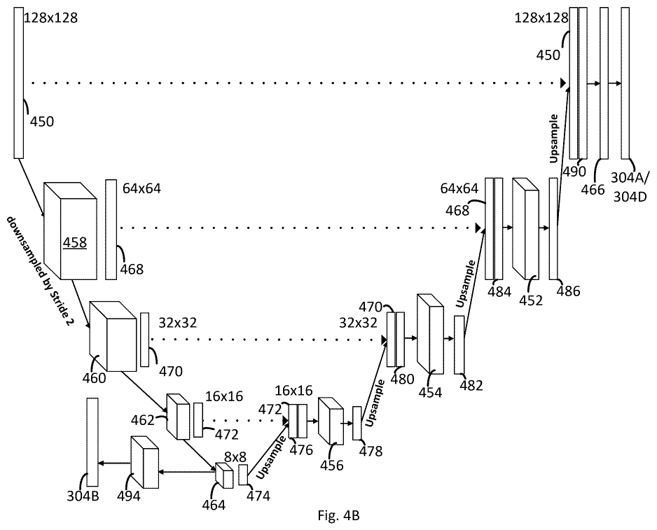

As shown further in FIGS. 4A and 4B described herein below, the all points portion of branch 306, the eye points branch 308, and lip points branch 310 are structured with 16, 12, and 12 inverted residual blocks, respectively, each followed by an output layer that generates a landmark heatmap representation.

FIG. 4A is a block diagram showing additional structure 400 for eye and lip points branches 306 and 308, each comprising a plurality of inverted residual blocks 402 as noted above, and the heatmap block 404 to generate a landmark heatmap representation. The branch concludes with a respective prediction 304C or 304D.

The all points branch 306 directly uses features from backbone 302, while the eye and lip points branches 308 and 310 take the RoI-aligned crop features (via crops 314 or 316 providing crop operations) of those backbone features from blocks 302C. The eye and lip crops are respectively based on the predicted locations of the eyes and lips as received from the all points prediction 304B, which in an embodiment, the respective points are cached as further described. Lip segmentation branch 312 also receives a cropped lip region as does the crop received at lip points branch 310.

In an embodiment as shown in FIG. 4B for a representative 128×128 backbone feature size (e.g. extracted features 450), the segmentation branches 306 and 312 are designed following a U-Net architecture (O. Ronneberger, P. Fischer, and T. Brox, ‘U-net: Convolutional networks for biomedical image segmentation’, in Medical image computing and computer-assisted intervention—MICCAI 2015: 18th international conference, Munich, Germany, Oct. 5-9, 2015, proceedings, part III 18, 2015, pp. 234-241; incorporated herein by reference).

The face segmentation portion of branch 306 reuses the features from the all points head (portion) of branch 306 as the encoder. The lip segmentation branch 312 shares the same input RoI crop as the lip points branch 310 but operates independently without utilizing any features from the lip points branch 310.

The segmentation component of branch 306 and lip segmentation branch 312 comprise a plurality of inverted residual blocks (452, 454, and 456), points branch blocks (458, 460, 462 and 464), convolutional layers (466), extracted features (450, 468, 470, 472, 474, 478, 482, 486, and 488), upsampling blocks 476, 480, 484, 490, as well as a segmentation prediction (304A or 304D). In the case of branch 306, an all points prediction 304B is also provided following a heat map block 494. The structure performs upsampling such as shown. In an embodiment, each upsampling block (e.g. 480), receives a concatenation of an upsampled feature from the layer below (e.g. at 478) and the feature from the layer horizontally to the left (the dotted line) (e.g. at 470). The concatenated input passes through an inverted residual block (e.g. 454).

At inference time (e.g. a real-time execution for an application), the image (e.g. a frame of a video) is first processed by the all points head (i.e. the points prediction portion of branch 306 such as shown in FIGS. 4A/4B) that predicts face points to calculate the RoI crop, followed by prediction refinement for the eye and lip regions. To enhance temporal coherence, such as in lipstick rendering, and to address occlusion cases, the intersection between the lip segmentation mask and the lip points prediction is calculated, further refining prediction using optical flow calculations (e.g. Lukas-Kanada Optical Flow).

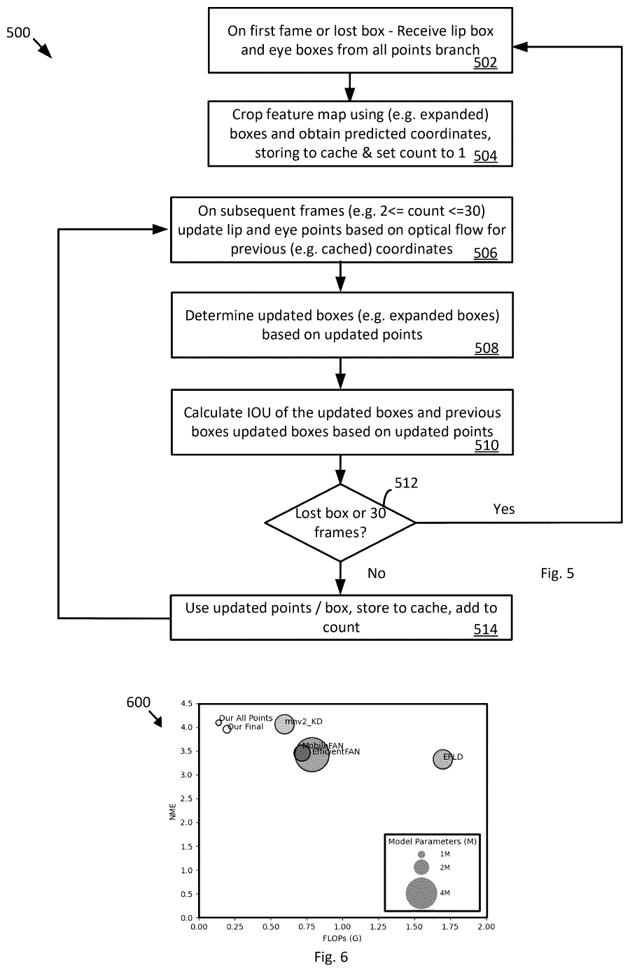

To optimize inference speed, in an embodiment, there is cached the eye and lip RoI parameters (e.g. respective lip points and eye points from the set of initial face points predicted by the all points branch 306, which lip points and eye points are used to determine a bounding box for the lip region crop and eye region crops). In an embodiment, these RoI parameters are cached to cache 342 under direction of block 340 every 30 frames or sooner when significant movement of these points occurs. In an embodiment, a measure of movement (e.g. pixel movement) between frames for each of the face landmark regions of interest (e.g. lip region and eye regions) is determined by block 340 using optical flow techniques. In an embodiment, block 340 comprises a frame counter and an optical flow measurer (for measuring movement of each of the regions of interest). In an embodiment, operations of block 340 are in accordance with the flowchart of FIG. 5 showing steps of operations 500, which are simplified.

On the first frame or lost box (at 502), get the lip box and eye boxes from the predicted all points branch 306. In an embodiment, the respective boxes use [min(X), min(Y), max(X), max(Y)] as the predicted box. In an embodiment these predicted boxes are expanded for cropping the feature map, for example, expanding width n %; height m % to get the adjusted boxes. At 504, operations crop feature map based on lip box and eye boxes to get predicted coordinates.

On subsequent frames (e.g. at 506) e.g. following an immediately prior determination by prediction via steps 502-505 or if frame count is <=30, calculate updated lip/eye points based on application of optical flow function to previous (cached) points. In an embodiment, updated points are determined using: (1−a)(x,y)+a*optical_flow(x,y), where a is the alpha (weighting factor) of how much the points will updated based on optical flow.

At 508 operations determine expanded boxes using the updated points determined using optical flow (see box determination and expansion herein above).

At 510, operations calculate the intersection over union (IOU) of the updated adjusted boxes and previous adjusted boxes (e.g. from the cache).

In an embodiment, when IOU<k, operations determine there is a lost box, where k is threshold for redetecting using the all points branch.

At 512, after 30 frames or lost boxes operations loop, via the “Yes” branch, to step 502 to obtain predicted coordinates via the all points branch. Otherwise, via the “No” branch, operations at 514 use the updated points, storing same to cache for (potential) next frame use and add to the frame count before looping to step 506.

In an embodiment, movement of the lips may drive a earlier/sooner caching of the parameters independently from caching of the eye movement, or vice versa.

An embodiment using such caching allows for parallel processing of the all-points branch with the other branches for refinement and/or segmentation. The other branches are enabled to use the cached ROI parameters for e.g. up to 30 frames or sooner (fewer), as directed by the optical flow measurement, rather than using frame-by-frame results from the all points prediction component of branch 306. Without caching, the eye and lip point branches need to wait for the all point head to calculate the approximate location of the lip and eye RoI crop location. With caching, for at least some of the frames (up to about every 30 frames), the branches for lip and eye refinement no longer have to wait for the all point head to complete first because the RoI crop location is approximate by previous detected RoI crop location. The refinement branches have reduced dependency on the operations of the all points branch, allowing all point head and other point branches to run parallelly, thereby speeding up the inference time.

In an embodiment, a speedup achieved through parallelization and caching allows the model to be deployed on older edge devices (e.g. user devices such as smartphones having fewer or less powerful computational resources).

Training Pipeline and Loss Functions: We initially train the backbone and all points branches. Afterward, we freeze these components and proceed to train the remaining branches collectively.

Landmark Loss (Lpt): Given an input image of W×H and each landmark pₙ, we define a heatmap Mᵢ, size

$$⌊ \frac{W}{k} ⌋ \times ⌊ \frac{H}{k} ⌋$$

from a 2D Gaussian distribution of [symbol] (μ, Σ) where μ is the corresponding position of the landmarks coordinates (x, y) and σₓ and σ_{y} are hyper-parameters. The predicted value [symbol] is the expected value from the normalized heatmap distribution. We calculate the overall loss as the sum of a weighted cross entropy loss between the ground truth heatmap M and the predicted heatmap \hat{M} and the L2 regression loss on the normalized coordinates as the following:

$${L}_{pt} = {\sum }_{n = 1}^{N} {\sum }_{i = 1}^{W} {\sum }_{j = 1}^{H} {w}_{ij} * {L}_{CE} ( M , \hat{M} ) + λ * {‖ {p}_{n} - \hat{{p}_{n}} ‖}_{2} t \qquad ( 1 )$$

where wᵢⱼ is calculated based on the normalized square distance:

$${w}_{i j} = \frac{{( {i}^{l} - {i}^{\hat{l}} )}^{2} + {( {j}^{l} - {j}^{\hat{l}} )}^{2}}{{⌊ \frac{W}{k} ⌋}^{2} + {⌊ \frac{H}{k} ⌋}^{2}} \qquad ( 2 )$$

Segmentation Loss (Lₘₐₛₖ): In an embodiment, a pixel-wise cross-entropy loss was used when training both the face segmentation branch and the lip segmentation branch.

Overall Losses: In an embodiment, the all points branch was first trained and frozen. Then the rest of the branches were trained together, in which:

$${L}_{stage 1} = {L}_{pt}^{All} ; {L}_{stage 2} = {L}_{pt}^{Eye} + {L}_{pt}^{Lip} + {L}_{mask}^{Lip} + {L}_{mask}^{Face} \qquad ( 3 )$$

to benchmark the landmark prediction performance, the model was evaluated using the 300-W dataset comprising images from AFW, HELEN, IBUG and LFPW, where the 300-W dataset is annotated with 68 landmarks. The 300-W dataset contains 3,148 training images and 689 test images. The test images are further divided into common (554 images) and challenging (135 images) subsets. We report the normalized mean error (NME), the number of parameters, and FLOPs in Table I. table shows a model comparison based on average NME of 68 landmarks of 300-W full, common, and challenging datasets, as well as the number of model parameters and flops. We use the interocular distance as normalization for NME.

TABLE I

| Model | #Params(M) ↓ | FLOPs(G) ↓ | Full↓ | Common↓ | Challenge↓ |
|---|---|---|---|---|---|
| LAB [12] | 25.1 | 19.1 | 3.49 | 2.98 | 5.19 |
| MobileFAN [7] | 2.01 | 0.72 | 3.45 | 2.98 | 5.34 |
| EfficientFAN [8] | 4.19 | 0.79 | 3.42 | 2.98 | 5.21 |
| EFLD [9] | 2.3 | 1.7 | 3.32 | 2.88 | 5.03 |
| mnv2KD [10] | 2.4 | 0.6 | 4.06 | 3.56 | 6.13 |
| Present all | 0.71 | 0.14 | 4.09 | 3.53 | 6.39 |
| point branch | | | | | |
| herein | | | | | |
| Present final | 1.05 | 0.20 | 3.95 | 3.38 | 6.27 |
| point model | | | | | |
| herein | | | | | |

As makeup VTO requires more detailed inner face point information, we perform an ablation study on eye and lip points branches using our dataset, which contains 65 landmarks, as shown in Table II. Table II shows a comparison of average eye points, lip points, and overall NME before and after adding the lip points and eye points branch.

TABLE II

| Model | Lip ↓ | Eye ↓ | All Points ↓ |
|---|---|---|---|
| All points branch | 4.38 | 3.15 | 4.31 |
| Final model | 3.31 | 2.48 | 3.45 |

Table III and FIG. 6 present the metrics for our lip and face segmentation modules. Table III shows the mean intersection over union (mIoU), precision and recall of the segmentation branches.

TABLE III

| Branch | mIoU | mPre | mRec |
|---|---|---|---|
| Face segmentation | 90.74 | 95.66 | 94.64 |
| Lip segmentation | 77.78 | 82.53 | 92.63 |

FIG. 6 is a graph 5600 providing a comparison of landmark NME based on 300-W full set, number of model parameters (M) and FLOPs (G) with other models.

We select the TensorFlow.js (TFjs) framework to deploy our models across the website. The inference time of the optimized inference pipeline on iPhone 14 is 16 ms. Table IV lists the number of model parameters and FLOPs for each part based on the model that infers 65 landmarks.

TABLE IV

| Parts | # Params (M) | FLOPs (G) |
|---|---|---|
| Backbone | 0.001 | 0.013 |
| All Point | 0.708 | 0.121 |
| Eye Point | 0.170 | 0.038 |
| Lip Point | 0.170 | 0.019 |
| Lip Seg | 0.072 | 0.045 |
| Face Seg | 0.306 | 0.095 |
| Total | 1.425 | 0.331 |

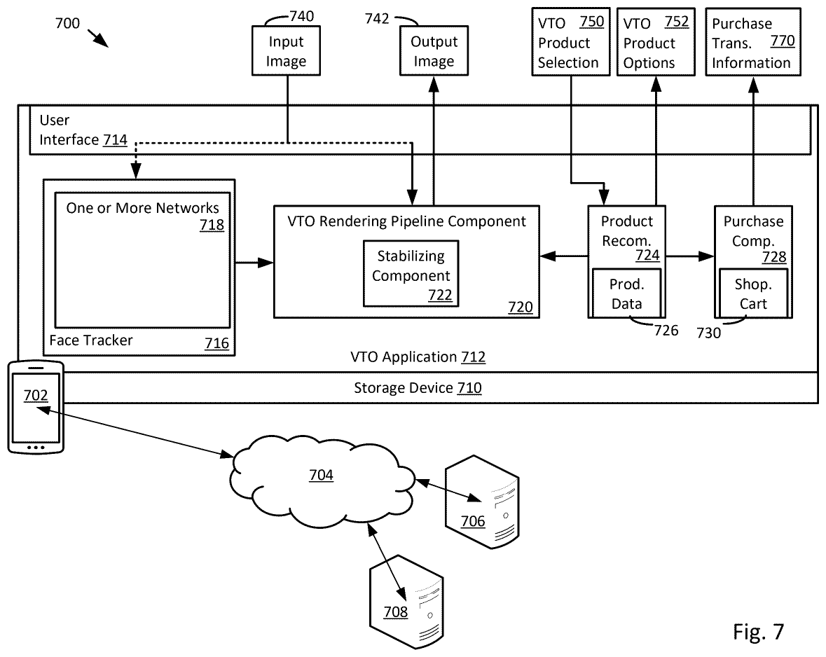

FIG. 7 is an illustration of a computing environment 700, in accordance with an embodiment, such as for practicing one or more method aspects, for example, VTO operations. Computing environment 700 shows a user computing device 702, such as a smartphone, a communications network 704, a server 706 and a server 708. Communications network 704 comprises wired and/or wireless networks, which may be public or private and may include, for example the internet. Server 706 comprises a server computing device such as for providing a website. Server 708 comprises a server computing device such as for providing e-commerce transaction services. Though shown separately, the servers 706 and 708 can comprise one server device. Computing environment is simplified. For example, not shown are payment transaction gateways and other components such as for completing an e-commerce transaction.

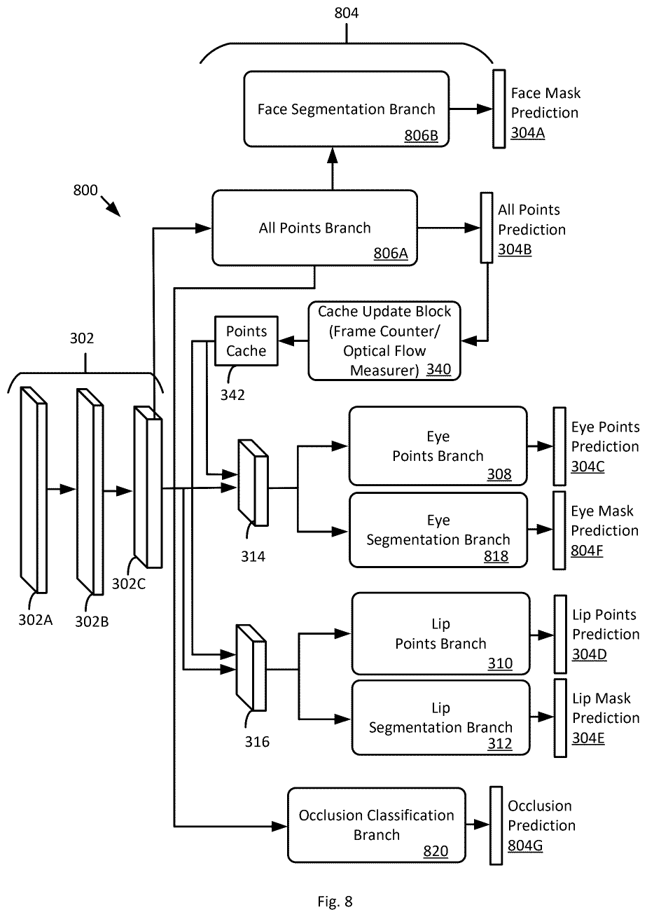

Computing device 702 comprise a storage device 710 (e.g., a non-transient device such as a memory and/or solid-state drive, etc.) for storing instructions that, when executed by at least one processor (not shown), cause the computing device 702 to perform operations such as a computer implemented method. Many computing devices have more than one processor such as a central processing unit (CPU) and a graphics processing unit (GPU) (which may have multiple instances of processors in a unit). Storage device 710 stores a VTO application 712 comprising components such as software modules providing, a user interface 714, face tracker 716, with one or more neural networks 718 configured for face detection including determining face points, a VTO rendering pipeline component 720 with a stabilization component 722, a product recommendation component 724 with product data 726, and a purchasing component 6728 with shopping cart 730 (e.g. purchase data). One of the one or more neural networks 718 comprises a network according to a framework as described herein, for example, in an embodiment, comprising a face tracker network 300 or a face tracker network 800 (See FIG. 8).

In an embodiment, VTO application is a web-based application such as is obtained from server 706. Though not shown, user device 702 may store a web-browser for execution of web-based VTO application 712. In an embodiment, VTO application 712 is a native application in accordance with an operating system (also not shown) and software development or other requirements that may be imposed by a hardware manufacturer, for example, of the user device 702. The native application can be configured for web-based communication or similar communications to servers 706 and 708, as is known.

FIG. 7 shows various input and output data or information associated with a use of VTO application 712, for example. Such includes an input image 740 of the user to be processed for a VTO experience, an output image 742 to which product effects are simulated providing a VTO experience, a VTO product selection 750 comprising user input selecting one or more product effects to be simulated, VTO products options 752 comprising options for products to be virtually tried on, for example for selection by a user of device 702, and purchase transaction information 760 comprising purchase information provided to and/or received from a user to purchase a product.

In an embodiment, via one or more of user interfaces 714, VTO product options 752 are presented for selection to virtually try on by simulating effects on an input image 740. In an embodiment the VTO product options 752 are derived from or associated to product data 726. In an embodiment, the product data 726 can be obtained from server 706 and provided by the product recommendation component 724. Though not shown, user or other input may be received for use to determine product recommendations. The user may be prompted, such as via one of interfaces 714 to provide input for determining product recommendations. In an embodiment, the product recommendation component 724 communicates with server 706. Server 706, in an embodiment, determines the recommendation based on input received via component 714 (e.g. and 724) and provides product data accordingly. User interface 714 can present the VTO product choices, for example, updating the display of same responsive to the data received as the user browses or otherwise interacts with the user interface 714.

In an embodiment, the one or more user interfaces 714 provide instructions and controls to obtain the input image 740, and VTO product selection input 750 such as an identification of one or more recommended VTO product options 752 to try on. In an embodiment, the input image 740 is a user's face image, which can be a still image or a frame from a video. In an embodiment, the input image 740 can be received from a camera (not shown) of device 702 or from a stored image (not shown). The input image 740 is provided to face tracker 716 such as for processing to detect objects in the face image using one or more networks 718 as trained. In an example, the network classifies, localizes or segments for an object such as a hand, glasses, a protective facemask (or other occluding object) in the image. In an embodiment, example classification for protective facemask presence is useful to output a request (e.g. an instruction to a user such as via user interfaces 714), to lower or remove the protective facemask. Such is applicable to any occluding object for which the face tracker engine is trained. In an embodiment, occlusion can be handled at rendering, such as described herein, to avoid rendering over an occlusion.

In an embodiment, output (specifics not shown) from the face tracker 716, such as classification results, localization results or segmentation results for one or more detected objects, is provided to VTO rendering pipeline component 720. In an example, the output may comprise a bounding box (e.g. 110, 112, 114, 116, 118 120 of FIG. 1) and, as shown in FIGS. 1 and 2, face points 102/104 (e.g. groups thereof) for detected objects, and any determined segmentation masks such as face mask 304A, 304D or similar outputs of network 800. Input image 740 is also provided (e.g. made available) to VTO rendering pipeline component 720. The VTO product selection 750 is also provided to VTO rendering pipeline component 720 for determining which effects are to be rendered. In an embodiment related to makeup simulation, one or more effects can be indicated such as for any one or more of the product categories comprising: lip, eye shadow, eyeliner, blush, etc.

VTO rendering pipeline component 720, in an embodiment, determines whether to render one or more product effects to the input image 740 to simulate a try on. For example, responsive to occlusion classification output, VTO rendering pipeline component 720 can determine not to render a product effect, for example, because an occlusion is detected. When a facemask is detected, for example, VTO rendering pipeline component 720 can, optionally, trigger the user interface 714 to ask the user to remove the facemask. A new image (new instance of image 740) can be received and processed by face tracker 716. In an embodiment, images are continuously received as a component of a live stream (e.g. a selfie video, chat video, conference video, etc.). In an embodiment, occlusions are dealt with at rendering so as to avoid rendering over an inclusion, such as described herein.

If VTO rendering pipeline component 720 determines to render the one or more product effects, in an embodiment VTO rendering pipeline component 720 renders effects on the input image 740 such as by drawing (rendering) effects in layers, one layer for each product effect, to produce output image 742. Portions of the operations of VTO rendering pipeline component 720 (e.g. such as for drawing the layers) can be performed by a GPU, in an embodiment. The rendering is in accordance with product data 726 as selected by VTO product selection 750 and is responsive to the location of detected objects. For example, a VTO product selection of a lipstick, lip gloss or other lip related product invokes the application of an effect to one or more detected mouth or lip-related objects at respective locations. Similarly a brow-related product selection invokes the application of a selected product effect to the detected eye brow objects. Typically, for symmetrical looks, the same brow effects are applied to each brow, the same lip effect to each lip or the same eye effect to each eye region, but this need not be the case.

In an example, the rendering is applied to a region of the image that is relative to the detected objects, such as adjacent one or more such detected objects (e.g. between an eye and a brow). Some VTO product selections comprise a selection of more than one product (e.g. defining a “look”) such as coordinated products for brows and eyes or other combinations of detected objects, including the whole face. Product data can define respective “looks” grouping associated products, for example, and associating the look with a name for display via the user interface, such as displayed associated with a control enabling user selection of a look from a group of looks in presented in a list, array or other presentation format. VTO rendering pipeline component 720 can render each effect, for example, one at a time until all effects are applied. The order of application can be defined by rules or in the selection of products e.g. lipstick before a top gloss. etc.

In an embodiment where an occluding object is detected and the location is determined, for example, as represented in a segmentation mask, the rendering can be responsive to such a segmentation mask. Rendering of an effect can be applied to portions of the face that are not occluded. A segmentation mask can indicate the pixels of the face that are available to (e.g. may) receive an effect such as a makeup effect and those pixels that are not available to receive an effect.

User interface 714 provides the output image 742. Output image 742, in an embodiment, is presented as a portion of a live stream of successive output images (each an example of image 742) such as where a selfie video is augmented to present an augmented reality experience. In an embodiment, output image 742 is presented along with the input image 740, such as in a side-by-side display for comparison. In an embodiment, output image 742 can be saved (not shown) such as to storage device 710 and/or shared (not shown) with another computing device.

In an embodiment, (not shown) the input images comprise input images of a video conferencing session and the output images comprise a video that is shared with another participant (or more than one) of a video conferencing session. In an embodiment the VTO application is a component or plug in of a teleconsultation application or a video conferencing application (each not shown) permitting the user of device 702 to wear makeup during a teleconsultation or video conference (respectively) with one or more other conference participants.

In an embodiment, VTO rendering pipeline component 720 is configured to apply object stabilization (e.g. using stabilising component 722) to stabilize respective locations of detected objects between, for example, successive frames of a video. In an embodiment, stabilization is performed using optical flow techniques.

In an embodiment, face tracker 716 localizes facial features but without detecting facemask (or other occluding object) presence. As a result, in such an embodiment, the operations of VTO rendering pipeline component 720 are configured without accounting for occlusions.

In accordance with an embodiment (not shown), an application for performing a teleconsultation or video chat or video conference incorporates an integrated virtual try on such that a user can appear to have selected makeup effect during a chat or conference. It will be a similar environment to environment 700 can be configured. In a video chat or video conference environment, a user device provides a teleconsultation or video conferencing application having integrated VTO features. Application is stored to a non-transient storage device. Integrated VTO features are provided such as by the components of a VTO application.

The user device is configured to communicate with a server providing video chat or conferencing services thereby to communicate with one or more other user devices. Examples of platforms providing a video conferencing service, which are not to be limiting, include MICROSOFT TEAMS™ available from Microsoft Corporation of Redmond, WA; ZOOM ONE™ available from Zoom Video Communications, Inc. of San Jose, CA; and GOOGLE MEET™, available from Google LLC of Mountain View Parkway, among others.

In brief, teleconsultation or video conferencing services permit sharing of live video between two or more user devices communicating via an intermediary device, namely a server. A first user device obtains a video stream from a camera (either an internal or external camera coupled thereto) and provides it to server for communication to other participant devices (e.g. and their respective users (e.g. conference members in video conferencing, a clinician or beauty advisor in teleconsultation)) that are participating in the conference as maintained by the conference or chat server. Such a server provides respective video streams received from the respective user devices to other user device for the conference or chat. It is understood that the server may process (e.g. perform video processing of) any of the video streams it receives and retransmits for a conference or teleconsultation.

Respective user teleconsultation or video conference applications executing on the respective devices can be configured to present the received video streams such as in accordance with a selected layout or view in a user interface on a display device. A layout or view may show a member who is the active speaker or a pinned conference member or all conference members, etc. as is known.

In an embodiment, the conference or chat application is configured to apply at least one effect to the images originated by the user device, enabling a virtual try on during the teleconsultation or video conferencing meeting, so that other members receive the output images as rendered using the integrated VTO application with the at least one effect applied.

An input image represents a frame of an input video stream originated from a camera local to the user device while an output image represents a frame of an output video stream determined from one or more frames of the input video stream. Each output image is presented in accordance with the user interface or other controls of the application. Thus at sometimes during the teleconsultation or conference, the output image may not be displayed by the user device such as when another member has a focus and only that member's stream is being presented. However, the output image is communicated to the server for retransmission for (e.g. selective) display by other user devices according to the respective controls of their local teleconsultation or video conference applications. It is understood that no VTO effects are applied if the camera control is “off”, and no camera images are shared out to server.

In an embodiment, the teleconsultation, conference or chat application is configured with user interfaces having controls to enable a user to select whether to have a VTO effect applied. In an embodiment, the user interface is enabled to receive user input to select a preview of an effect(s), invoking the VTO components to process the input video stream and render an output video stream with the effect(s) rendered for display by the user's device. In an embodiment, during the preview, the output video stream is not shared to the server and thus not provided to other devices during the period of the preview. In embodiment, the user interface is enabled to present detailed information about each of the products of the effects and further enabled to permit purchasing of products.

FIG. 8 is a block diagram of a network structure 800 in accordance with an embodiment. Structure 800 is similar to structure 300 and similar components have the same reference numbers. Structure 800 includes backbone 302 and seven components (collectively 704). Backbone 302 comprises image crop 302A, convolutional layer 302B and inverted residual blocks 302B. The seven components 704 of structure 700 are similar to those of structure 300. Whereas FIG. 3 shows an all points+face segmentation branch 306, FIG. 8 shows two branches 806A and 806B for all points head and face segmentation portions respectively. The structure shown in FIG. 4A applies to branch 706B and the structure shown in FIG. 4B applies as may be adapted for segmentation operations in structure 800. Eye point branch 308, lip point branch 310 and lip segmentation branch 312 and crops 314 and 316 are also components of structure 800.

Added in structure 800 is an eye segmentation branch 818 as well as occlusion classification branch 820. Eye segmentation branch 818 produces an eye segmentation prediction 804F, for example, respective eye masks for each eye. Occlusion classification branch 820 produces occlusion predictions 804G.

Eye segmentation branch 818 has a similar structure to the segmentation structure of FIG. 4B in relation to the lip segmentation branch 312, for example. It is understood that the structure of FIG. 4B can be adapted for a different crop size, for example, a starting crop size of 64×64. An additional upsampling followed by an additional inverted residual block operation for the resulting 128×128 extracted features can be performed just prior to obtaining a 128×128 prediction.

In an embodiment, points from all points branch 806A are cached such as described with reference to block 340 and points cache 342.

FIG. 9 is a block diagram of occlusion classification branch 820, in accordance with an embodiment. Flattened features 902 from the backbone are each processed by respective sub-classifier branches to predict occlusions. For each prediction, occlusion branch 820 comprises respectively a first fully connector layer (collectively 904, a LeakyReLU function (collectively 906), a second fully connected layer (collectively 908) and the occlusion prediction 804G (having components 910A, 910B, 910C and 910D for each of left eye, right eye, face and lips occlusion predictions). In an embodiment, the occlusion probabilities for left eye, right eye, lip and face comprise a probability for each facial part that measures whether that part is occluded.

As per structure 300 in FIG. 3, backbone 302 in structure 800 comprises of a convolution layer followed by an inverted residual block. It takes the input RGB images and computes the features that will be fed into various branches for predicting landmarks, segmentation mask or occlusion classification.

In all points branch 806A, similar to branch 306 in terms of the face points prediction, the all points head takes the whole output features from the backbone as input and predicts the approximate 2D coordinates of the 65 facial key points. The all point heads output sixty-five 2D heatmaps and the 2D coordinates for each keypoint are calculated based on the weighted-average of the coordinates in each heatmap. The all point branch is trained using landmarks loss. The structure is shown in more detail in FIG. 4A for example. The loss function is described further below.

Left eye cropped features from 314 are directly passed to the eye segmentation branch 818 to infer a binary segmentation mask (e.g. components of 804F) that predicts facial skin and non-skin around the eye region (for eye & eyebrow as previously noted). The right eye cropped features from 314 are flipped horizontally before processing via the eye segmentation branch 818 and then the predicted right eye masks are flipped horizontally again to get the un-flipped masks (components of 804F). Eye segmentation branch 818 is optimized through training based on the segmentation loss. See FIG. 4B showing structure of the model architecture in accordance with an embodiment as well as description in relation to different sample size for more details regarding segmentation branch structure. See too the loss function section for more details regarding the segmentation loss.

In an embodiment, based on the outer lip points (e.g. #10-22) predictions from the all points prediction 304B, a lip bounding box (e.g. see FIG. 1) is created that centers at the average outer points, and the width and length are computed to include all the outer lip points, and then scaled horizontally by 1.75 and vertically by 1.5. Using the lip bounding box, a region of interest (RoI) align crop (See He, K., Gkioxari, G., Dollar, P. and Girshick, R., 2017. Mask r-cnn. In Proceedings of the IEEE international conference on computer vision (pp. 2961-2969), incorporated herein by reference) is cropped (316) from the backbone feature map. The cropped lip features are then passed to the lip points branch 310 and lip segmentation branch 312 for more precise lip points and mask prediction.

In an embodiment, lip points branch 310 predicts 21 heatmaps and the final lip coordinates (#10-30) are based on the weighted average in heatmaps. The lip points branch 310 is optimized during training based on the landmark loss. An embodiment of structure is shown in FIG. 4A.

In an embodiment, lip segmentation branch 312 predicts a 128*128 binary mask that predicts if each pixel within the lip bounding box is a lip pixel or non lip pixel. The lip segmentation branch 312 is optimized during training based on the segmentation loss. An embodiment of structure is shown in FIG. 4B.

In an embodiment, the overall structures of eye point and eye segmentation branches 308, 818 are similar to the structure of the lip point and segmentation branches 310, 312. Based on the left and right eye and eyebrow points (left eye and eyebrow points: #41-63; right eye and eyebrow points: #31-56, 64) predicted from the all points branch, there is created two eye bounding boxes for left eyes & eyebrow and right eyes & eyebrow, and then two ROI align crops are cropped (314) from the backbone features based on the boxes.

The left eye cropped features are directly passed to the eye points branch 308 to infer more precise eye and eyebrow points. The right eye cropped features are flipped horizontally before passing to the eye points branch 308 and then the predicted 2D right eye and eyebrow coordinates from the eye points branch 308 are flipped horizontally again to get the un-flipped coordinates for prediction 304C. The eye points branch 308 is optimized through training based on the landmark loss and has, in an embodiment, structure shown in FIG. 4A.

In an embodiment, the left eye cropped features are directly passed to the eye segmentation branch 818 to infer a binary segmentation mask (component of 804F) that predicts facial skin and non-skin around the eye region. The right eye cropped features are flipped horizontally before passing to the eye segmentation branch 818 and then the predicted right eye masks are flipped horizontally again to get the un-flipped masks (component of 804F). The eye segmentation branch is optimized through training based on the segmentation loss and has, in an embodiment, structure shown in FIG. 4B or otherwise described herein.

Occlusion Classifier: In an embodiment, the occlusion classification branch 820 takes the features of the second last layer of the all points head 806A as input and computes four binary classifications for left eye, right eye, lip and face occlusion. In an embodiment, the features from the all point branch are reused to speed up the calculations. The occlusion classifier consists of four binary classifier heads, each head has 2 fully connected layers followed by a softmax layer (not shown). The last layer of each mini classifier predicts the probabilities that whether each part is occluded or not. The classifier is optimized via training based on the classification loss and structure such as shown in accordance with an embodiment in FIG. 9.

Landmark Training Data: In an embodiment, both labeled data and unlabeled data was used for training the landmark prediction models. For labeled data, 6000 portrait images were collected and annotated with the 65 facial landmarks (see FIG. 2). An annotation tool (software application) was used to define the annotations. For unlabeled data, 7000 images were collected that cover edge cases in portrait images, including subjects with makeup, with thin/thick lips, with extreme expression, when talking and when moving the head around. Subjects from different ages, genders and ethnicities were sampled.

Landmark Testing Data: In an embodiment, 10% of the 6000 labeled training data was set aside for testing and validation. In an embodiment, 100 of the 7000 unlabeled training data was set aside, manually annotated and used for testing against the edge cases. Any images used for evaluation are removed from the training dataset.

Lip, Eye and Eyebrow, Whole Face Segmentation Training Data: In an embodiment, 10,000 synthetic hand dataset was acquired through the DataGen platform (DataGen Israel). The unoccluded images were filtered out from the landmark labeled dataset. Segmented out were the synthetic hand pixels from these hand images and they were pasted into real unoccluded portrait images. To create more variety of hands, scaling, flipping and rotation augmentation on the hands was performed. To increase realism, the average RGB of the synthetic hands was scaled based on the facial skin in the real portrait images. Also acquired was a dataset that contains some other synthetic objects that are commonly seen in portrait images, such as glasses, facial masks (e.g. for nose and mouth masking for respiratory protection), mugs, eating utensils and other snacks. Similar to the synthetic hand, those objects were cropped and pasted to the unoccluded real portrait images to create an occluded dataset. The same augmentation techniques as synthetic hands were applied.

In an embodiment, given the ground truth landmark labels on the real portrait images, the ground truth labels for the lip masks are created by first recreating a lip mask based on drawing a polygon from the lip points, then the part of the lip mask that is occluded by the synthetic inserted objects is removed. In an embodiment a same process is performed for eye, eyebrow and whole face, using their corresponding face points.

Lip, Eye and Eyebrow, Whole Face Segmentation Testing and Validation Data: In an embodiment, for quantitative evaluation, 10% of the training data was set aside for testing and validation. These images used for evaluation are removed from the training dataset. For qualitative evaluation, the real occluded images were used and also separately collected were internally-sourced videos where subjects move their hands with different gestures in front of the face.

Occlusion Classifier Training and Testing Data: In an embodiment, the classifier was trained based on 40,000 images with partial occlusion labels that indicate whether any of the face, left eye, right eye or mouth is occluded. For qualitative evaluation, the same videos from the segmentation branch were used for evaluation.

Landmark Data Correction: It was observed that human bias in annotations that annotators tend to provide average out their annotations, such that the lip points for people with thinner lips tends to be slightly outside the actual lip edge whereas lip points for people with thicker lips tends to be slightly inside the actual lip edge. This is undesirable as it tends to cause bias in the trained model. To improve the quality of the landmarks, first trained was the whole model (i.e. the all points branch model that predicts the 65 landmarks) using the original landmarks as ground truth.

In embodiment, since the segmentation model is sensitive to lip edges, the ground truth lip points were adjusted to be on the edge of the lip segmentation masks. The lip points were moved based on the nearest point on the edge. After the ground truth labels were updated, the point branches are retrained.

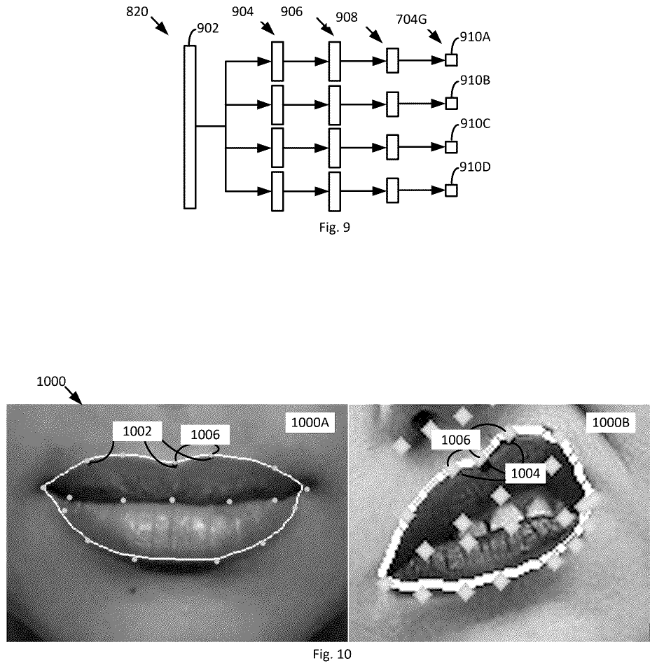

FIG. 10 is a pair of images 1000 showing a first annotation and adjusted annotation examples for lips. Images 1000 comprising a first image 1000A and second image 1000B. FIG. 10 shows an adjustment of ground truth lip points based on a segmentation mask where the white lip indicates the edge of the lip segmentation mask. Dark shaded points (e.g. 1002, 1004) are points before adjusting showing the initial upper lip points are inside the lip instead of on actual lip edge. Light shaded points e.g. 1006, 1008) are the final lip points after adjusting based on the lip mask.

Human-In-The-Loop Annotation System: During training and error analysis, edge cases were identified where insufficient data was collected in the samples in the initial labeled dataset. To facilitate the quantitative analysis and future improvement on these edge cases, first sampled were unlabeled images based on the selected edge cases. These images along with annotation predictions were then uploaded to an annotation tool to adjust the annotations manually. The newly annotated images can be either used for more in-depth error analysis or training data.

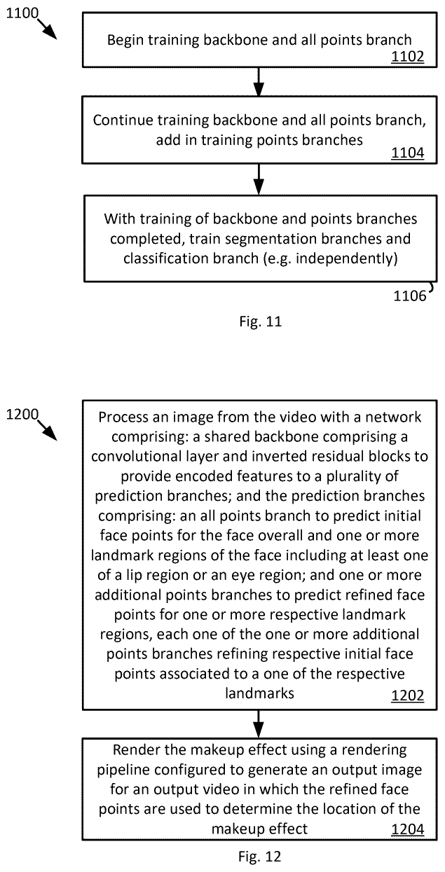

FIG. 11 is a flowchart of operations 1100 in accordance with an embodiment showing training steps such as for architecture 800. Operations 1100 can be modified for architecture 300 as will be apparent to a person of ordinary skill in the art. At 1102 operations train (e.g. pre-train) the backbone 302 and the all points branch 806A using landmark loss for the all points head. The weights can be randomly initialized.

At 1104, training operations continue training of the backbone 802 and the all points branch 806A, and add in training of the eye points branch 808 and the lip points branch 810.

At 1106, with training of the backbone 302, all points branch 806A, eye points branch 308 and lip points branch 310 completed, the segmentation branches 806B, 312 and 818, and classification branch 820 are trained, e.g. independently, with the weights of the completed branches frozen/remaining unchanged. The initial weights of the segmentation branches 806B, 312 and 818, and classification branch 820 can be randomized.

Loss Functions: The all points branch 806A, eye points branch 308 and lip points branches 310 are trained based on landmark losses. The lip, eye, whole face segmentation branches (312, 818, 806B) are trained based on pixel-wise binary cross entropy with logit loss. The occlusion classifier is trained based on weighted binary cross entropy loss.

In an embodiment, for training at 1002:

$$Pretraining Total Loss = {LandmarkLoss}_{all point branch}$$

In an embodiment, for fine-tuning training at 1004:

$$Finetuning Total Loss = {LandmarkLoss}_{all point branch} + {LandmarkLoss}_{lip point branch} + {LandmarkLoss}_{eye \& eyebrow point branch} + {SegmentationLoss}_{whole face seg branch} + {SegmentationLoss}_{lip seg branch} + {SegmentationLoss}_{eye \& eybrow seg branch} + {ClassificationLoss}_{occlusion classification branch}$$

Landmark Loss: in an embodiment, there is applied a pixel wise sigmoid cross entropy (Ning Zhang, Evan Shelhamer, Yang Gao, and Trevor Darrell. Fine-grained pose prediction, normalization, and recognition. arXiv preprint arXiv:1511.07063, 2015; incorporated herein by reference) to learn the heatmaps, which is denoted as Lₕ. Additionally, to alleviate issues with the heatmaps being cut off for landmarks near boundaries, there is added on an L2 distance loss with a loss weight λ. The calculation of landmark losses for all points branch, lip points branch and eye points branch is the same, the only difference is that the all points branch's loss are based on all 65 points, the lip points and eye points branches' losses are only based on the corresponding lip or eye & eyebrow points. In an embodiment, the landmark loss is determined according to:

$${L}_{landmark} = {L}_{h} + λ \cdot {L}_{2}$$

$${L}_{h} = \frac{1}{N} {\sum }_{1}^{N} {\sum }_{1}^{L} {\sum }_{1}^{W} {\sum }_{1}^{H} [ {ρ}_{ij}^{l} log {ρ}_{ij}^{\hat{l}} + ( 1 - {ρ}_{ij}^{l} ) log ( 1 - {ρ}_{ij}^{\hat{l}} ) \cdot {w}_{ij}^{l ′} ]$$

$${w}_{ij}^{l} = \frac{( {( {i}^{n} - {i}_{l}^{\hat{n}} )}^{2} + {( {j}^{n} - {j}_{l}^{\hat{n}} )}^{2} ) \cdot 2}{{W}^{2} + {H}^{2}} ,$$

where pᵢⱼ^{l} is the prediction value of the heatmap in the l th channel at pixel location (i, j) of n's sample, while p^{\hat{l}}ᵢⱼ is the corresponding wᵢⱼ^{l} ground truth. is the weight at that location, which is calculated from Equation 3. (i^{\hat{n}}ₗ, j^{\hat{n}}ₗ) is the ground truth coordinate of the n's sample's l th landmark. It is noted that the landmark loss function Lₚₜ described herein above with reference to Eq. 1 is a simplified representation of the landmark loss equation here.

Segmentation Loss: There was applied a pixel-wise binary cross entropy with logit loss between the ground truth lip mask and the predicted lip mask, in an embodiment in which:

$$SegmentationLoss = {\sum }_{j = 1}^{W} {\sum }_{i = 1}^{H} [ {x}_{ij} log {\hat{x}}_{ij} + ( 1 - {x}_{ij} ) log ( 1 - {\hat{x}}_{ij} ) ] ,$$

where, xᵢⱼ is a pixel in the ground truth mask at coordinate (i, j) and \hat{x}ᵢⱼ is a predicted pixel value in the output mask at (i, j). It is noted that the segmentation loss function Lₘₐₛₖ described herein above with reference to Eq. 1 is a simplified representation of the segmentation loss equation here.

Classification Loss: We apply a weighted binary cross entropy loss on each of the four occlusion classifier heads. Since we have more negative occlusion labels in our data, we weight the negative sample by 0.3 and positive sample by 0.7 to reduce the impact of unbalanced data.

$$ClassificationLoss = \frac{1}{4} {\sum }_{c = 1}^{4} [ 0.7 {z}_{c} log {\hat{z}}_{c} + 0.3 ( 1 - {z}_{c} ) log ( 1 - {\hat{z}}_{c} ) ]$$

where Z_{c} is the ground truth label (0 or 1) of whether facial part c is occluded and and \hat{Z}_{c} is a predicted occlusion probability for facial part c.

Result measures are shown in the following tables for embodiments of network 800 trained in accordance with the proposed operations 1000 and using the loss functions described in the context of FIG. 11. Table V shows error measures for landmarks, Table VI shows IoU measures for lip segmentation and Table VII shows accuracy measures for each type of occlusion classification.

TABLE V

| Measure | |
|---|---|
| Normalized Inner Error | 0.0343 |
| Normalized Overall Error | 0.0368 |

TABLE VI

| Measure | |
|---|---|
| Lip Intersection over Union | 0.794 |
| Background Intersection over Union | 0.946 |

TABLE VII

| Measure | |
|---|---|
| Face Negative Accuracy | 0.861 |
| Face Positive Accuracy | 0.912 |
| Left Eye Negative Accuracy | 0.97 |
| Left Eye Positive Accuracy | 0.709 |
| Mouth Negative Accuracy | 0.895 |
| Mouth Positive Accuracy | 0.897 |
| Right Eye Negative Accuracy | 0.976 |
| Righteye Positive Accuracy | 0.909 |
| Overall Negative Accuracy | 0.926 |
| Overall Positive Accuracy | 0.857 |

FIG. 12 is a flow chart of operations 1200 in accordance with embodiment. Operations 1200 simulate a makeup effect to images of a video to generate an output video. At 1202 operations process an image from the video with a network comprising: a shared backbone comprising a convolutional layer and inverted residual blocks to provide encoded features to a plurality of prediction branches including an all points branch to predict initial face points for the face overall and one or more landmark regions of the face including at least one of a lip region or an eye region; and one or more additional points branches to predict refined face points for one or more respective landmark regions, each one of the one or more additional points branches refining respective initial face points associated to a one of the respective landmarks.

At 1204 operations render the makeup effect using a rendering pipeline configured to generate an output image for an output video in which the refined face points are used to determine the location of the makeup effect.

Aspects and features from the embodiments will be apparent to a person of ordinary skill in the art and include those in the following numbered statements.
Statement 1: A system comprising at least one processor, a non-transient storage device coupled to the at least one processor, the storage device storing instructions executable by the at least one processor to cause the system to: provide a network trained for facial landmark detection, the network comprising a plurality of respective prediction branches to predict face points associated with facial landmarks in face images; and process, using the network, an input image comprising a face to obtain and provide face points for the facial landmarks; and wherein the network comprises: a shared backbone comprising a convolutional layer and inverted residual blocks to provide encoded features to the respective branches; an all points branch to predict initial face points for the face overall and one or more landmark regions of the face, the one or more landmark regions comprising at least one of a lip region or an eye region; and one or more additional points branches to predict refined face points for one or more respective landmark regions, each one of the one or more additional points branch refining respective initial face points associated to a one of the respective landmarks.
Statement 2: The system of Statement 1, wherein the one or more additional points branches comprise: a lip points branch to predict refined lip points; or an eye points branch to predict refined eye points; or the lip points branch and the eye points branch.
Statement 3: The system of Statement 1 or 2, wherein each additional points branch: comprises a plurality of residual blocks and a heatmap prediction block to determine the prediction of the refined face points; and is configured to receive a region of interest (RoI) crop of encoded features for the respective landmark region associated to the additional points branch, the RoI crop determined using respective initial face points associated to the respective landmark.
Statement 4: The system of any one of Statements 1 to 3, wherein the eye region includes a right eye and a right eyebrow and a left eye and a left eyebrow.
Statement 5: The system of any one of Statements 1 to 4, wherein the plurality of branches comprises one or more segmentation branches to predict one or more respective segmentation masks, the one or more segmentation branches comprising at least one of: a face segmentation branch to predict a face mask for the face overall, the face segmentation branch responsive to face features encoded by the all points branch; or a lip segmentation branch to predict a lip mask for the lips, the lip segmentation branch responsive to initial lip points obtained from the initial face points; or an eye segmentation branch to predict an eye mask for the eyes, the eye segmentation branch responsive to initial eye points obtained from the initial face points.
Statement 6: The system of Statement 5, wherein the lip segmentation branch comprises a lip points model having a plurality of inverted residual blocks, the lip points model configured to receive a lip region of interest (RoI) crop of encoded features, the lip RoI crop determined using respective initial face points associated to the lip region; and wherein the eye segmentation branch comprises an eye points model having a plurality of inverted residual blocks, the eye points model configured to receive an eye region of interest (RoI) crop of encoded features, the eye RoI crop determined using respective initial face points associated to the eye region.
Statement 7: The system of any one of Statements 1 6, wherein the network is trained using training steps: a) pre-training the shared backbone and the all points branch; and b) continuing the training of the shared backbone and all points branch while adding in the training of the additional points branches until trained.
Statement 8: The system of Statement 7, wherein: the plurality of branches comprises one or more segmentation branches to predict one or more respective segmentation masks, the one or more segmentation branches configured to encoded features and/or initial face points from the all points branch; and the training steps further comprise c) training the one or more segmentation branches following training step b).
Statement 9: The system of Statement 8, wherein: the training steps use first training data having bias in the annotations; and the network is further trained by repeating the training steps, including training the segmentation branches, using refined training data in which at least some of the bias in the annotations of the first training data is removed.
Statement 10: The system of Statement 8, wherein the network is trained such that the all points branch and the one or more additional points branches are each trained using a landmark loss and the one or more segmentation branches are each trained using a segmentation loss.
Statement 11: The system of claim 1, wherein the network comprises an occlusion classifier branch comprising a plurality of classifiers to provide occlusion predictions for occlusions over at least a part of the face, the occlusions predictions including respective predictions for one or more of the eye region or the lip region.
Statement 12: The system of Statement 11, wherein the instructions are executable to further cause the system to apply an effect to the input image using the refined face points for at least one landmark region.
Statement 13: The system of Statement 12, wherein the effect simulates a product or service applied to the face to provide a virtual try on experience.
Statement 14: The system of Statement 13, wherein the product comprises a makeup product or an appliance product; and the service comprises a cosmetic procedure or a surgical procedure or other face altering procedure.
Statement 15: The system of Statement 12, wherein the network comprises an occlusion classifier branch comprising a plurality of classifiers to provide occlusion predictions for occlusions over at least a part of the face, the occlusions predictions including respective predictions for one or more of the eye region or the lip region and wherein the instructions to apply an effect are responsive to the occlusions predictions.
Statement 16: The system of any one of Statements 1 to 15, wherein the network is a component of or communicates with an application and the facial landmarks are provided for further use by the application, wherein the application comprises any of a VTO application; a teleconsultation application, a video chat application, a video conference application, or a facial recognition application.
Statement 17: The system of any one of Statements 1 to 16, wherein one or both of: the instructions are executable to further cause the system to: provide a cache and caching block to cache the respective initial face points for regions of interest, and operate the all points branch in parallel with the one or more additional points branches such that the all points branches operate on images from successive frames of a video without waiting for initial face points for at least some of the frames from the all points branch; or the plurality of branches comprises one or more segmentation branches to predict one or more respective segmentation masks, each of the one or more segmentation branches associated with a respective one of the one or more additional points branches; and the instructions are executable to further cause the system to: provide a cache and caching block to cache the respective initial face points for regions of interest, and operate the all points branch in parallel with the one or more additional points branches and the one or more segmentation branches such that the all points branches and one more segmentation branches operate on images from successive frames of a video without waiting for initial face points for at least some of the frames from the all points branch
Statement 18: A method to simulate a makeup effect to images of a video, the method comprising: processing an image from the video with a network trained for facial landmark detection, the network comprising a plurality of respective prediction branches to predict face points associated with facial landmarks in face images, wherein the network comprises: a shared backbone comprising a convolutional layer and inverted residual blocks to provide encoded features to the respective branches; an all points branch to predict initial face points for the face overall and one or more landmark regions of the face, the one or more landmark regions comprising at least one of a lip region or an eye region; and one or more additional points branches to predict refined face points for one or more respective landmark regions, each one of the one or more additional points branch refining respective initial face points associated to a one of the respective landmarks; and rendering the makeup effect using a rendering pipeline configured to generate an output image for an output video in which the refined face points are used to determine the location of the makeup effect.
Statement 19: The method of Statement 18, wherein the network further comprises one or more segmentation branches to provide respective segmentation masks for locating the makeup effects, the segmentation branches configured to process: i) features encoded by the all points branch and/or ii) initial face points predicted by the all points branch; and wherein the method comprises processing the input image with the one or more segmentation branches to provide the respective masks for use to render the makeup effect by the rendering engine.
Statement 20: The method of Statement 18 or 19, wherein the network further comprises an occlusion classifier branch comprising at least one occlusion classifier to predict at least one occlusion of the face; and the method comprises: processing the image using the occlusion classification branch; and providing the at least one occlusion prediction; and wherein the rendering is responsive to the at least one occlusion prediction.
Statement 21: The method of any one of Statements 18 to 20, wherein the output video is generated for any of a VTO application; a teleconsultation application, a video chat application or a video conference application.
Statement 22: A method to track landmarks of an object in images of a video comprising processing an image using a network configured with a shared backbone (e.g. having inverted residual branches) to provided encode features to a plurality of prediction branches, the branches including a first points branch to predict initial points for the landmarks, one or more refined points branches to refine the initial points for respective subregion landmarks of the object and one or more segmentation branches to predict segmentations masks for the object, including mask for at least some of the respective subregion landmarks; and providing at least some of the initial points as refined or the one or more segmentation masks to track the object in the video.
Statement 23: The method of statement 22 comprising rendering an effect to the object for an output image of an output video, the rendering using the points as refined and/or segmentations masks to locate the effect relative to the object.

In accordance with embodiments, there is disclosed a novel, tiny, unified model for face alignment and segmentation that accurately predicts facial landmarks while effectively handling occlusions by leveraging the segmentation mask to identify camera-visible regions. The lightweight model boasts superior speed, making it ideal for deployment in real-time, web-based makeup virtual try-on applications.

Practical implementation may include any or all of the features described herein. These and other aspects, features and various combinations may be expressed as methods, apparatus, systems, means for performing functions, program products, and in other ways, combining the features de-scribed herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or re-moved from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, un-less the context requires otherwise. By way of example and without limitation, references to a computing device comprising a processor and/or a storage device includes a computing device having multiple processors and/or multiple storage devices. Herein, “A and/or B” means A or B or both A and B.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

It will be understood that corresponding computer implemented method aspects and/or computer program product aspects are also disclosed. A computer program product, for example, comprises a storage device storing computer readable instructions that when executed by at least one processor of a computing device causes the computing device to perform operations of a computer implemented method.

1. A system comprising at least one processor, a non-transient storage device coupled to the at least one processor, the storage device storing instructions executable by the at least one processor to cause the system to:
provide a network trained for facial landmark detection, the network comprising a plurality of respective prediction branches to predict face points associated with facial landmarks in face images; and
process, using the network, an input image comprising a face to obtain and provide face points for the facial landmarks; and
wherein the network comprises:
a shared backbone comprising a convolutional layer and inverted residual blocks to provide encoded features to the respective branches;
an all points branch to predict initial face points for the face overall and one or more landmark regions of the face, the one or more landmark regions comprising at least one of a lip region or an eye region; and
one or more additional points branches to predict refined face points for one or more respective landmark regions, each one of the one or more additional points branch refining respective initial face points associated to a one of the respective landmarks.

2. The system of claim 1, wherein the one or more additional points branches comprise:
a lip points branch to predict refined lip points; or
an eye points branch to predict refined eye points; or
the lip points branch and the eye points branch.

3. The system of claim 1, wherein each additional points branch:
comprises a plurality of residual blocks and a heatmap prediction block to determine the prediction of the refined face points; and
is configured to receive a region of interest (RoI) crop of encoded features for the respective landmark region associated to the additional points branch, the RoI crop determined using respective initial face points associated to the respective landmark.

4. The system of claim 1, wherein the eye region includes a right eye and a right eyebrow and a left eye and a left eyebrow.

5. The system of claim 1, wherein the plurality of branches comprises one or more segmentation branches to predict one or more respective segmentation masks, the one or more segmentation branches comprising at least one of:
a face segmentation branch to predict a face mask for the face overall, the face segmentation branch responsive to face features encoded by the all points branch; or
a lip segmentation branch to predict a lip mask for the lips, the lip segmentation branch responsive to initial lip points obtained from the initial face points; or
an eye segmentation branch to predict an eye mask for the eyes, the eye segmentation branch responsive to initial eye points obtained from the initial face points.

6. The system of claim 5, wherein the lip segmentation branch comprises a lip points model having a plurality of inverted residual blocks, the lip points model configured to receive a lip region of interest (RoI) crop of encoded features, the lip RoI crop determined using respective initial face points associated to the lip region; and wherein the eye segmentation branch comprises an eye points model having a plurality of inverted residual blocks, the eye points model configured to receive an eye region of interest (RoI) crop of encoded features, the eye RoI crop determined using respective initial face points associated to the eye region.

7. The system of claim 1 wherein one or both of:
the instructions are executable to further cause the system to: provide a cache and caching block to cache the respective initial face points for regions of interest, and operate the all points branch in parallel with the one or more additional points branches such that the all points branches operate on images from successive frames of a video without waiting for initial face points for at least some of the frames from the all points branch; or
the plurality of branches comprises one or more segmentation branches to predict one or more respective segmentation masks, each of the one or more segmentation branches associated with a respective one of the one or more additional points branches; and the instructions are executable to further cause the system to: provide a cache and caching block to cache the respective initial face points for regions of interest, and operate the all points branch in parallel with the one or more additional points branches and the one or more segmentation branches such that the all points branches and one more segmentation branches operate on images from successive frames of a video without waiting for initial face points for at least some of the frames from the all points branch.

8. The system of claim 1, wherein the network is trained using training steps: a) pre-training the shared backbone and the all points branch; and b) continuing the training of the shared backbone and all points branch while adding in the training of the additional points branches until trained.

9. The system of claim 8, wherein:
the plurality of branches comprises one or more segmentation branches to predict one or more respective segmentation masks, the one or more segmentation branches configured to encoded features and/or initial face points from the all points branch; and
the training steps further comprise c) training the one or more segmentation branches following training step b).

10. The system of claim 9, wherein:
the training steps use first training data having bias in the annotations; and
the network is further trained by repeating the training steps, including training the segmentation branches, using refined training data in which at least some of the bias in the annotations of the first training data is removed.

11. The system of claim 9, wherein the network is trained such that the all points branch and the one or more additional points branches are each trained using a landmark loss and the one or more segmentation branches are each trained using a segmentation loss.

12. The system of claim 1, wherein the network comprises an occlusion classifier branch comprising a plurality of classifiers to provide occlusion predictions for occlusions over at least a part of the face, the occlusions predictions including respective predictions for one or more of the eye region or the lip region.

13. The system of claim 1, wherein the instructions are executable to further cause the system to apply an effect to the input image using the refined face points for at least one landmark region.

14. The system of claim 13, wherein: the effect simulates a product or service applied to the face to provide a virtual try on experience; the product comprises a makeup product or an appliance product; and the service comprises a cosmetic procedure or a surgical procedure or other face altering procedure.

15. The system of claim 12, wherein the network comprises an occlusion classifier branch comprising a plurality of classifiers to provide occlusion predictions for occlusions over at least a part of the face, the occlusions predictions including respective predictions for one or more of the eye region or the lip region and wherein the instructions to apply an effect are responsive to the occlusions predictions.

16. The system of claim 1, wherein the network is a component of or communicates with an application and the facial landmarks are provided for further use by the application, wherein the application comprises any of a VTO application; a teleconsultation application, a video chat application, a video conference application, or a facial recognition application.

17. A method to simulate a makeup effect to images of a video, the method comprising:
processing an image from the video with a network comprising:
a shared backbone comprising a convolutional layer and inverted residual blocks to provide encoded features to a plurality of prediction branches; and
the prediction branches comprising:
an all points branch to predict initial face points for the face overall and one or more landmark regions of the face including at least one of a lip region or an eye region; and
one or more additional points branches to predict refined face points for one or more respective landmark regions, each one of the one or more additional points branches refining respective initial face points associated to a one of the respective landmarks; and
rendering the makeup effect using a rendering pipeline configured to generate an output image for an output video in which the refined face points are used to determine the location of the makeup effect.

18. The method of claim 17, wherein the network further comprises one or more segmentation branches to provide respective segmentation masks for locating the makeup effects, the segmentation branches configured to process: i) features encoded by the all points branch and/or ii) initial face points predicted by the all points branch; and wherein the method comprises processing the input image with the one or more segmentation branches to provide the respective masks for use to render the makeup effect by the rendering engine.

19. The method of claim 17, wherein the network further comprises an occlusion classifier branch comprising at least one occlusion classifier to predict at least one occlusion of the face; and the method comprises: processing the image using the occlusion classification branch; and providing the at least one occlusion prediction; and wherein the rendering is responsive to the at least one occlusion prediction.

20. The method of claim 17, wherein the output video is generated for any of a VTO application; a teleconsultation application, a video chat application or a video conference application.
